(19) United States
(12) Patent Application Publication
(10) Pub. No.: US 2026/0111227 A1
(43) Pub. Date: Apr. 23, 2026

(54) Processing Instructions

(71) Applicant: Imagination Technologies Limited, Kings Langley (GB)

(72) Inventor: Peter Vrabel, Hertfordshire (GB)

(21) Appl. No.: 19/323,190

(22) Filed: Sep. 9, 2025

(30) Foreign Application Priority Data
Sep. 9, 2024 (GB) 2413197.1

(51) Int. Cl. G06F 9/22; G06F 9/26

(52) U.S. Cl. CPC G06F 9/223; G06F 9/226; G06F 9/262

(57) ABSTRACT

A vector processing unit contains an operation cache and a separate micro-op cache. The operation cache tracks state and logic of instructions, and is responsible for splitting instructions into micro-ops. The micro-op cache tracks state and logic of micro-ops. Having a separate micro-op cache provides power and area benefits, as well as allowing instructions to be split out of order.

### CROSS-REFERENCE TO RELATED APPLICATIONS AND CLAIM OF PRIORITY

This application claims foreign priority under 35 U.S.C. 119 from United Kingdom Patent Application No. GB2413197.1 filed on 9 Sep. 2024, the contents of which are incorporated by reference herein in their entirety.

### TECHNICAL FIELD

The present disclosure relates to the processing of instructions by a processing unit, e.g. a vector processing unit.

### BACKGROUND

A vector processing unit (VPU) is responsible for executing vector instructions and scalar floating-point instructions, which may include cryptographic instructions. The VPU receives decoded instructions from a central unit (e.g. a main pipeline control (MPC)) and then executes the instructions. Execution is primarily performed by reading the vector or floating point register files, sending the data through a vector data path, and then writing the result back to the vector or floating point register file.

Any given instruction may be split into multiple micro-operations (micro-ops). Each micro-op is executed separately, and is either sent to a load-store unit (LSU) for performing memory access operations in response to load and store instruction types, or to a vector data path (VDP) which contains vector and floating-point computation logic.

Different instructions may take a different amount of time/cycles to execute. The VPU therefore requires storage to track the state of each instruction and each micro-op. For example, the VPU may need to track know how many more cycles it will take for an instruction or micro-op to complete. The VPU also requires scheduling logic to dispatch and execute the micro-ops correctly.

### SUMMARY

This Summary is provided merely to illustrate some of the concepts disclosed herein and possible implementations thereof. Not everything recited in the Summary section is necessarily intended to be limiting on the scope of the disclosure. Rather, the scope of the present disclosure is limited only by the claims.

Existing VPUs may have an operation cache (OC) that tracks the control and state for micro-ops of VPU instructions which have not yet fully written to the register file, control status register (CSR), or LSU. Since the OC only tracks the micro-ops, instructions need to be split into their multiple respective micro-ops at the head of the CPU's pipeline. Each micro-op is then issued (i.e. sent) to the VPU. The VPU then executes each micro-op. The micro-ops may or may not be executed in the order in which the micro-ops are received from the CPU. However, instructions cannot be executed out of order. That is, instructions must be executed in the order they are sent to the VPU.

This arrangement is costly from a power perspective as it is required to store control state for longer than it is needed. It is also costly from an area perspective. Since an instruction is split into all micro-ops (before it reaches the OC), entries are required for each micro-op.

In addition, this use of the OC suffers from a scaling problem—as the number of micro-ops from a given instruction increases, as does the number of entries (and therefore size) required in the OC.

Existing VPUs may not have an OC. In this case the VPU has a normal pipeline that executes micro-ops in order. The splitting of instructions needs to be done at the head of the pipe. Again, instructions cannot be executed out of order with this system.

The present invention introduces a new cache, separate from the operation cache (OC), to track the state and control logic of micro-ops. This new cache is referred to as a micro-op cache (NOC). Each cache (the OC and OC) has multiple entries. Each entry of the OC tracks the state and control logic of a single instruction. Each entry of the μOC tracks the state and control logic of a single micro-op.

With this new arrangement, instructions no longer need to be split into micro-ops before being sent to the VPU. Instead, the whole instruction is sent to the VPU, e.g. from a main pipeline control (MPC) of the CPU. The OC is responsible for splitting the instruction into the required micro-ops, which are then sent to the μOC. The μOC is responsible for executing the micro-ops.

With this arrangement, the OC can split the micro-ops of an instruction out-of-order, i.e. the micro-ops can be sent to the μOC in a different order compared to an initial ordering of micro-ops of the instruction. Similarly, the OC can execute the micro-ops out-of-order. Having the ability to execute micro-ops out-of-order can result in better performance. For example, an add instruction may be followed by a multiply instruction. The micro-ops for each of the instructions, once split, may be dispatched out-of-order, e.g. one or more micro-ops from the multiply instruction may be dispatched before one or more micro-ops from the add instruction. However, at the time of execution, the data required by micro-ops of the add instruction may not be available. If the micro-ops had to be executed in order, the micro-ops of the multiply instruction could not start executing until those of the add instruction had executed. Now, the order of execution can be switched such that the micro-ops of the multiply instruction are executed first.

In addition, as the OC is responsible for splitting the instruction into multiple micro-ops, the OC can determine how to split the instruction into micro-ops, rather than the MPC/CPU. The OC may split the instruction based on the data that the instruction is to operate on. This may result in fewer micro-ops being split from a given instruction. For instance, the number of micro-ops required may be dependent on architectural state that may not be known until the instruction reaches the VPU. As a particular example, in RISC V, the number of micro-ops required may be dependent on the data in the VTYPE and VL registers. More generally, in any vector architecture there is likely to be some form of mask/predicate register that would affect the number of micro-ops. Now that the splitting happens at the OC, which has access to the architectural state, the OC can choose the optimum number of micro-ops, or at the very least avoid splitting an instruction into all its micro-ops. Specifically, VL determines how many elements of a vector need to be processed by an instruction. VL can be tracked by the OC, leading to fewer micro-ops. The fewer micro-ops per instruction, the more efficient the processing of the instruction.

When the OC splits the instruction into micro-ops, the logic for each micro-op is put into a separate entry of the OC. The μOC entry dispatches the micro-op, when required, and tracks the state of the micro-op. It also controls how data is sent to and from the units that perform the execution of the micro-op (which may be either the vector datapath or the memory system, depending on instruction type). When execution of the micro-op is complete (e.g. data has been written to register file), the μOC entry is emptied. Having a separate μOC to track micro-ops means that each entry of the OC entry is updated less frequently (generally once per instruction), as opposed to once per micro-op.

The new structure also allows for variable length pipelines, providing area savings due to less data forwarding. For example, previously, a micro-op may spend two cycles doing calculations but nothing for the remaining cycles. This means that the calculation has been performed but the result is still in the pipeline (of the vector datapath or an LSU) but cannot be easily extracted. Now, the result can be extracted from the middle of the pipeline when it has been calculated and sent to the MPC to be used.

According to one aspect disclosed herein, there is provided a computer-implemented method of processing an instruction by a processing unit. The processing unit comprises an operation cache (OC) comprising a plurality of entries and a micro-operation cache (OC) comprising a plurality of entries. The method comprises receiving, at the OC, an instruction to be processed by the processing unit and storing, in an entry of the OC, state and control logic associated with the instruction. The method further comprises splitting, by the OC, the instruction into a set of micro-operations and sending, by the OC, each of the set of micro-operations to the μOC. The method further comprises storing, in respective entries of the μOC, respective state and respective control logic associated with respective micro-operations of the set of micro-operations, and dispatching, by the μOC, one or more of the respective micro-operations for execution.

In embodiments, the instruction may comprise an original ordering of micro-operations, and wherein an ordering of the set of micro-operations differs from the original ordering.

In embodiments, the instruction may comprise an original number of micro-operations, and wherein the set of micro-operations comprises fewer than the original number of micro-operations.

In embodiments, the ordering of the set of micro-operations and/or the splitting of the instruction into the set of micro-operations may be based on the data to be processed by the instruction and/or architectural state.

In embodiments, the set of micro-operations may be sent to the μOC in initial ordering, and wherein the method may comprise dispatching, by the OC, one or more of the respective micro-operations in an order that differs from the initial ordering.

In embodiments, the method may comprise the OC updating the state associated with the instruction during execution of the instruction.

In embodiments, the method may comprise the OC updating the respective state associated with the respective micro-operations during execution of the respective micro-operations.

In embodiments, dispatching of a respective micro-operation by the μOC may comprise dispatching the respective micro-operation to a vector data path or a load-store unit of a memory system.

In embodiments, the method may comprise emptying the respective entry of the OC on completion of execution of the respective micro-operation.

In embodiments, the method may comprise emptying the entry of the OC on completion of execution of the instruction.

According to another aspect disclosed herein, there is provided a processing unit comprising an operation cache (OC) comprising a plurality of entries, and a micro-operation cache (μOC) comprising a plurality of entries. The OC is configured to receive an instruction to be processed by the processing unit, store, in an entry of the OC, state and control logic associated with the instruction, split the instruction into a set of micro-operations, and send each of the set of micro-operations to the μOC. The JOC is configured to store, in respective entries of the OC, state and control logic associated with a respective micro-operation of the set of micro-operations, and dispatch, for execution, one or more respective micro-operations of the set of micro-operations.

According to another aspect disclosed herein, there is provided A processing system comprising the processing unit of any embodiments described herein, a control unit configured to send an instruction to the processing unit, and a memory system comprising one or more load-store units, wherein the one or more load-store units are configured to receive and execute one or more respective micro-operations dispatched by the μOC.

The processing system may be embodied in hardware on an integrated circuit. There may be provided a method of manufacturing, at an integrated circuit manufacturing system, a processing system. There may be provided an integrated circuit definition dataset that, when processed in an integrated circuit manufacturing system, configures the system to manufacture a processing system. There may be provided a non-transitory computer readable storage medium having stored thereon a computer readable description of a processing system that, when processed in an integrated circuit manufacturing system, causes the integrated circuit manufacturing system to manufacture an integrated circuit embodying a processing system.

There may be provided an integrated circuit manufacturing system comprising: a non-transitory computer readable storage medium having stored thereon a computer readable description of the processing system; a layout processing system configured to process the computer readable description so as to generate a circuit layout description of an integrated circuit embodying the processing system; and an integrated circuit generation system configured to manufacture the processing system according to the circuit layout description. The layout processing system may be configured to determine positional information for logical components of a circuit derived from the integrated circuit description so as to generate the circuit layout description of the integrated circuit embodying the graphics processing system.

There may be provided computer program code for performing any of the methods described herein. There may be provided non-transitory computer readable storage medium having stored thereon computer readable instructions that, when executed at a computer system, cause the computer system to perform any of the methods described herein.

The above features may be combined as appropriate, as would be apparent to a skilled person, and may be combined with any of the aspects of the examples described herein.

### BRIEF DESCRIPTION OF THE DRAWINGS

Examples will now be described in detail with reference to the accompanying drawings in which:

FIG. 1 shows an example processing system for processing instructions by a vector processing unit;

FIG. 2 shows an example vector processing unit comprising a separate operation cache and micro-operation cache;

FIG. 3 shows a computer system in which a processing system is implemented; and

FIG. 4 shows an integrated circuit manufacturing system for generating an integrated circuit embodying a processing system.

The accompanying drawings illustrate various examples. The skilled person will appreciate that the illustrated element boundaries (e.g., boxes, groups of boxes, or other shapes) in the drawings represent one example of the boundaries. It may be that in some examples, one element may be designed as multiple elements or that multiple elements may be designed as one element. Common reference numerals are used throughout the figures, where appropriate, to indicate similar features.

### DETAILED DESCRIPTION

The following description is presented by way of example to enable a person skilled in the art to make and use the invention. The present invention is not limited to the embodiments described herein and various modifications to the disclosed embodiments will be apparent to those skilled in the art.

Embodiments will now be described by way of example only.

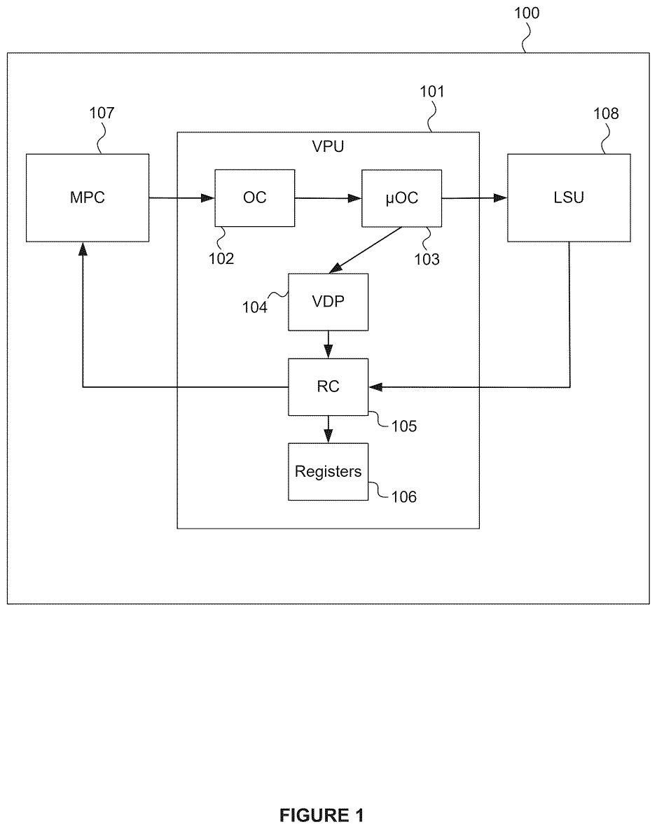

FIG. 1 illustrates an example processing system 100 for processing vector processing unit (VPU) instructions. Herein, a VPU instruction refers to any instruction processed (i.e. executed) by a VPU 101. For example, the instruction may be a vector instruction, a scalar floating-point instruction, a vector cryptographic instruction, or a matrix instruction.

The processing system 100 may be or form part of a RISC (e.g. RISC-V) processing system.

The VPU 101 includes an operation cache (OC) 102 and a micro-operation cache (OC) 103. The OC 102 contains decoder logic for splitting VPU instructions into one or more of their constituent micro-ops. The OC 102 also contains control and tracking logic for VPU instructions. The μOC 103 contains control and tracking logic for micro-operations of VPU instructions. The OC 102 and μOC 103 and their functions will be described in detail below.

According to embodiments, the OC 102 functions as more than just a simple cache in that it is also includes the logic for splitting instructions, previously found in the VPU, in order to decode the VPU instructions into the micro-ops to be sent to the μOC 103. In this sense, the term “operation cache” is used as a label for a component of the system that is configured to receive VPU instructions, split those VPU instructions into micro-ops, and send those micro-ops to the OC 103. The term “operation cache” should not be taken to mean that the component is only limited to conventional cache-like operations, including storing data. As discussed above, the operation cache 102 performs additional operations, namely the decoding/splitting of VPU instructions. To this end, any instance of the term “operation cache” used herein may be replaced with the term “operation management unit”.

The VPU 101 may also comprise a vector data path (VDP) 104 configured to calculate the result of data-processing VPU instructions, and a results cache (RC) 105 configured to store data for VPU instructions which have executed but not yet written back to memory (e.g. a register 106). The VPU 101 may comprise additional components.

The VPU 101 is configured to accept (i.e. receive) decoded VPU instruction control from a main pipeline control (MPC) 107 of the CPU. The MPC 107 is also commonly referred to as a data processing unit (DPU). Any reference to MPC below may be replaced with “control unit” or DPU. The VPU 101 is also configured to split VPU instructions into micro-ops, as will be described below. The VPU 101 is configured to track the state of in-flight VPU instructions. Here, “in-flight” means that an instruction has been issued but has not yet fully executed (e.g. written a result to a register or terminated). The VPU 101 is also configured to dispatch micro-ops, which may include sending control logic and data to one or more load-store units (LSUs) 108 to execute VPU load and store instructions, and receiving data from LSUs 108. The VPU 101 is also configured to dispatch micro-ops to the VDP 104. The VPU 101 may be configured to perform additional functions such as, for example, accepting scalar data from the MPC 107, returning scalar data to the MPC 107, and updating vector and floating-point register files 106.

The processing system 100 comprises an interface between the VPU 101 and the MPC 107, the interface being configured to pass VPU instructions and data between the VPU 101 and the MPC 107. The VPU 101 is configured to receive decoded instructions from the MPC 107, and then executes the instructions. Execution is primarily performed by reading the vector or floating point register files, sending the data through the VDP 104, then writing the result back to the vector or floating point register file.

The processing system 100 also contains one or more interfaces between the VPU 101 and LSUs 108, the LSUs 108 being configured to perform vector loads and stores and floating point loads and stores.

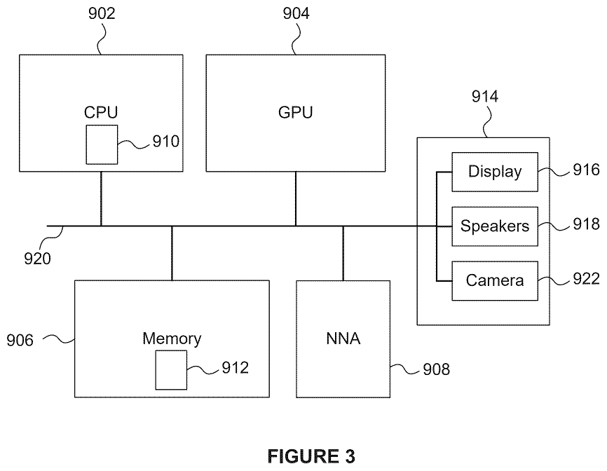

The VPU 101, MPC 107 and LSU 108 are all components of a central processing unit (CPU), e.g. CPU 902 shown in FIG. 3.

The VPU 101 may, in some situations, run ahead of the MPC 107, meaning that some instructions may have finished executing, and have the result available, before the instruction has been architecturally committed. In this case, the result is written to the result cache 105 and then sent from the result cache 105 into the appropriate register file 106 once the instruction is committed.

VPU instructions are sent from the MPC 107 to the VPU 101 in order. Instructions may be executed and perform architectural updates out of order, both with respect to other MPC instructions, and also with respect to other VPU instructions.

The following definitions are used throughout the present disclosure. “Issue” refers to when an instruction is sent from the MPC 107 to the VPU 101. The instruction enters the OC 102 at this point. “Dispatch” refers to when the OC 102 generates a micro-op from an instruction. The micro-op enters the μOC 103 at this point. This will cause the micro-op to be sent to the VDP 104 or LSU 108 at some later point. “Allow” refers to when an instruction or micro-op is allowed to perform actions that may have software-observable side effects (e.g. page walks or main memory reads). “Commit” refers to when an instruction or micro-op becomes guaranteed to update architectural state. It cannot do any such update until it's committed. “Execute” refers to when a micro-op produces a result (e.g. a result that can be written to the architectural state once the instruction is committed). “Writeback” refers to when the micro-op or instruction has finished updating architectural state (e.g. register 106) with a result.

Turning now to the operation of the OC 102 and the μOC 103. The OC 102 is configured to receive VPU instructions. The OC 102 is configured to track the control and state for VPU instructions which have not been written to the register file 106 (or other memory), or the LSU 108 for store operations. The OC 102 comprises a plurality of entries (OC entries). Each OC entry tracks one VPU instruction. An instruction may be associated with an identifier (e.g. assigned by the MPC or the VPU). The identifier may be used to determine which entry of the OC 102 is used by that instruction.

Each OC entry is associated with one instruction, and contains information (e.g. state and logic) specific to that instruction, which may include one or more of the following: an indication of how much of the instruction has been executed (e.g. how many micro-ops have been committed), micro-op exceptions, any guarantees for no exceptions, age tracking (e.g. youngest/oldest instruction compared to current instruction), program counter of instruction, a valid bit, VDP control or LSU control, read and write pointers, architectural state relevant to the execution of this instruction, information about the allow and/or commit status (or more generally, any relevant status relating to the instruction), hazarding information.

The OC 102 is configured to split a VPU instruction into multiple micro-ops, each of which is. capable of being accepted by an LSU 108 or the VDP 104. The MPC 107 is not aware of how an instruction is split into multiple micro-ops, or even if it is split.

The μOC 103 is configured to receive micro-operations of VPU instructions. The μOC 103 is configured to track the control and state for micro-ops which have been dispatched but have not yet written back their result. The μOC 103 comprises a plurality of entries (μOC entries). Each JOC entry tracks one micro-op. A micro-op may be associated with an identifier (e.g. assigned by the OC 102 or μOC 103). The identifier may be used to determine which entry of the μOC 103 is used by that micro-op.

Each μOC entry is associated with one micro-op, and contains information (e.g. state and logic) specific to that micro-op, which may include one or more of the following: an indication of how much of the micro-op is valid, a status of the micro-op, a pointer to the parent OC entry, a pointer to the RC entry where the result will be written to, exception information, a guarantee for no exception, a valid bit, a pointer to the parent instruction, information about the allow and/or commit status (or more generally, any relevant status relating to micro-op), hazarding information, age information that can be used to order the micro-op entry relative to other μOC entries.

The μOC 103 is configured to dispatch micro-ops for execution. For example, a micro-op may be dispatched to a LSU 108 or to the VDP 104. The JOC 103 may also be configured to control the writing of VDP results or load data into the RC 105.

The OC 102 may be configured to split a VPU instruction into micro-ops out of order. That is, the VPU instruction may contain an initial (i.e. original or default) ordering of micro-ops. The OC 102 may split the instruction into a set of micro-ops that have a different order compared to the initial ordering. As an example, an instruction may be composed of 3 micro-ops: micro-op 1, followed by micro-op 2, followed by micro-op 3. The instruction may be split into the same micro-ops, but in a different order, e.g. micro-op 2, followed by micro-op 1, followed by micro-op 3. In some examples, the micro-ops may be ordered in μOC entries in the different order. The splitting may be performed by the OC entry associated with the instruction.

The OC 102 may be configured to split a VPU instruction into fewer than an initial (i.e. original or default) number of micro-ops. That is, the VPU instruction may be composed of a maximum number of micro-ops for that instruction, and the OC 102 may split the instruction into less than the maximum number of micro-ops. Put another way, the OC 102 may choose not to split a VPU instruction into all of its micro-ops. As an example, an instruction may be composed of 3 micro-ops: micro-op 1, micro-op 2, and micro-op 3. The instruction may be split into only some of those micro-ops, e.g. just micro-op 2. The splitting may be performed by the OC entry associated with the instruction.

The OC 102 (or OC entry) may determine how the VPU instruction is to be split into micro-ops based on the data (e.g. the type of data) that is to be processed by the instruction (or the individual micro-ops of the instruction).

For example, in RISC-V, the architectural state ‘VL’ gives the number of elements to process. If this number is sufficiently low, less than the maximum number of micro-ops will need to be dispatched. More generally, most vector architectures, including RISC-V and Scalable Vector Extension (SVE), have a mask (i.e. a predicate) register which says which of the elements need to be processed. If a micro-op only operates on elements which do not need to be processed, that micro-op does not need to be dispatched.

Similarly, the OC 102 (or OC entry) may determine how the VPU instruction is to be split into micro-ops based on architectural state of the VPU 101, e.g. state of one or more registers.

For example, some instructions may only be able to process one element at a time. If the current element size if specified to be 64-bits, a 128-bit register will be split into 2 micro-ops. If the size if 8-bits, the same register will be split into 16 elements.

The μOC 103 may be configured to dispatch micro-ops out of order. That is, the OC 102 may send the micro-ops of a given instruction to the μOC 103 in an initial order, and the μOC 103 may dispatch those micro-ops (e.g. to an LSU or the VDP) in a different order. The micro-ops may be stored in entries of the μOC 103 in an order determined based on the splitting of the instruction by OC. The μOC 103 may dispatch the micro-ops in a different order to how they are stored in the OC entries. As an example, the OC 102 may split an instruction into 3 micro-ops: micro-op 1, followed by micro-op 2, followed by micro-op 3. The μOC 103 may dispatch the micro-ops in a different order, e.g. micro op 3, followed by micro-op 2, followed by micro-op 1. In some examples, the μOC 103 may be configured to dispatch micro-ops from different instruction out of order, e.g. one or more micro-ops of a later instruction may be dispatched before one or more micro-ops of an earlier instruction.

The OC 102 is configured to update the state associated with an instruction as the instruction is processed. That is, the information stored in an OC entry associated with the instruction is updated. Similarly, the μOC 103 is configured to update the state associated with a micro-op as the micro-op is processed. That is, the information stored in an OC entry associated with the micro-op is updated. The μOC entry associated with a micro-op may be cleared (or emptied) upon completion of execution of the micro-op (e.g. when the micro-op updates architectural state). Similarly, the OC entry associated with an instruction may be cleared (or emptied) upon completion of execution of the instruction (e.g. when each of the instruction's micro-ops have updated architectural state). The OC entry may be cleared as soon as it is no longer needed, which may be when both of the following are true: 1) no further interaction between the VPU 101 and the MPC 107 are needed for the relevant instruction, and 2) all necessary micro-ops have been dispatched.

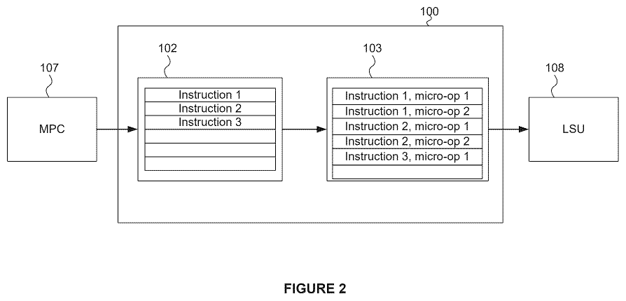

FIG. 2 schematically illustrates the interaction between the OC 102 and μOC 103. As shown, the OC 102 is configured to receive instructions from the MPC 107 and store, in separate entries of the OC 102, information relating to a single instruction. In this example, the OC 102 is currently storing information (e.g. state and logic) relating to three instructions. The OC 102 splits the instructions into micro-ops and sends the micro-ops to the μOC 103. The JOC is configured to store, in separate entries of the μOC 103, information relating to a single micro-op. In this example, the μOC 103 is currently storing information (e.g. state and logic) relating to five micro-ops: two micro-ops of a first instruction, two micro-ops of a second instruction, and one micro-op of a third instruction. Whilst embodiments of the invention have primarily been described using examples involving a VPU 101 processing VPU instructions, embodiments may apply equally to any component that receives instructions (decoded or not) that need to be split into smaller operations and executed. For example, a matrix-multiply accelerator may receive matrix-multiply instructions (e.g. from a central processing unit, main pipeline control, or data processing unit), store them in an OC, and split them into micro-ops to be sent to and stored in a μOC. Therefore any reference to vector processing unit may be placed with “processing unit” (PU) and any reference to “VPU instruction” may be replaced with PU instruction, unless the context requires otherwise.

FIG. 3 shows a computer system in which processing systems described herein may be implemented. The computer system comprises a CPU 902, a GPU 904, a memory 906, a neural network accelerator (NNA) 908 and other devices 914, such as a display 916, speakers 918 and a camera 922. A processing block 910 (corresponding to processing blocks 101) is implemented on the CPU 902. In other examples, one or more of the depicted components may be omitted from the system, and/or the processing block 910 may be implemented on the GPU 904 or within the NNA 908. The components of the computer system can communicate with each other via a communications bus 920. A store 912 is implemented as part of the memory 906.

The processing system of FIGS. 1 to 3 are shown as comprising a number of functional blocks. This is schematic only and is not intended to define a strict division between different logic elements of such entities. Each functional block may be provided in any suitable manner. It is to be understood that intermediate values described herein as being formed by a processing system need not be physically generated by the processing system at any point and may merely represent logical values which conveniently describe the processing performed by the processing system between its input and output.

The processing system described herein may be embodied in hardware on an integrated circuit. The processing system described herein may be configured to perform any of the methods described herein. Generally, any of the functions, methods, techniques or components described above can be implemented in software, firmware, hardware (e.g., fixed logic circuitry), or any combination thereof. The terms “module,” “functionality,” “component”, “element”, “unit”, “block” and “logic” may be used herein to generally represent software, firmware, hardware, or any combination thereof. In the case of a software implementation, the module, functionality, component, element, unit, block or logic represents program code that performs the specified tasks when executed on a processor. The algorithms and methods described herein could be performed by one or more processors executing code that causes the processor(s) to perform the algorithms/methods. Examples of a computer-readable storage medium include a random-access memory (RAM), read-only memory (ROM), an optical disc, flash memory, hard disk memory, and other memory devices that may use magnetic, optical, and other techniques to store instructions or other data and that can be accessed by a machine.

The terms computer program code and computer readable instructions as used herein refer to any kind of executable code for processors, including code expressed in a machine language, an interpreted language or a scripting language. Executable code includes binary code, machine code, bytecode, code defining an integrated circuit (such as a hardware description language or netlist), and code expressed in a programming language code such as C, Java or OpenCL. Executable code may be, for example, any kind of software, firmware, script, module or library which, when suitably executed, processed, interpreted, compiled, executed at a virtual machine or other software environment, cause a processor of the computer system at which the executable code is supported to perform the tasks specified by the code.

A processor, computer, or computer system may be any kind of device, machine or dedicated circuit, or collection or portion thereof, with processing capability such that it can execute instructions. A processor may be or comprise any kind of general purpose or dedicated processor, such as a CPU, GPU, NNA, System-on-chip, state machine, media processor, an application-specific integrated circuit (ASIC), a programmable logic array, a field-programmable gate array (FPGA), or the like. A computer or computer system may comprise one or more processors.

It is also intended to encompass software which defines a configuration of hardware as described herein, such as HDL (hardware description language) software, as is used for designing integrated circuits, or for configuring programmable chips, to carry out desired functions. That is, there may be provided a computer readable storage medium having encoded thereon computer readable program code in the form of an integrated circuit definition dataset that when processed (i.e. run) in an integrated circuit manufacturing system configures the system to manufacture a processing system configured to perform any of the methods described herein, or to manufacture a processing system comprising any apparatus described herein. An integrated circuit definition dataset may be, for example, an integrated circuit description.

Therefore, there may be provided a method of manufacturing, at an integrated circuit manufacturing system, a processing system as described herein. Furthermore, there may be provided an integrated circuit definition dataset that, when processed in an integrated circuit manufacturing system, causes the method of manufacturing a processing system to be performed.

An integrated circuit definition dataset may be in the form of computer code, for example as a netlist, code for configuring a programmable chip, as a hardware description language defining hardware suitable for manufacture in an integrated circuit at any level, including as register transfer level (RTL) code, as high-level circuit representations such as Verilog or VHDL, and as low-level circuit representations such as OASIS (RTM) and GDSII. Higher level representations which logically define hardware suitable for manufacture in an integrated circuit (such as RTL) may be processed at a computer system configured for generating a manufacturing definition of an integrated circuit in the context of a software environment comprising definitions of circuit elements and rules for combining those elements in order to generate the manufacturing definition of an integrated circuit so defined by the representation. As is typically the case with software executing at a computer system so as to define a machine, one or more intermediate user steps (e.g. providing commands, variables etc.) may be required in order for a computer system configured for generating a manufacturing definition of an integrated circuit to execute code defining an integrated circuit so as to generate the manufacturing definition of that integrated circuit.

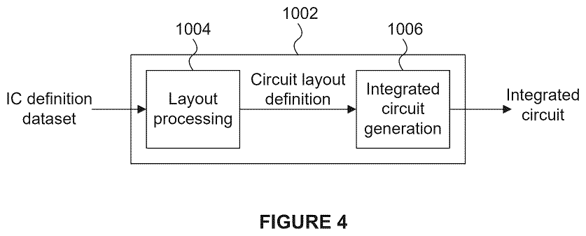

An example of processing an integrated circuit definition dataset at an integrated circuit manufacturing system so as to configure the system to manufacture a processing system will now be described with respect to FIG. 4.

FIG. 4 shows an example of an integrated circuit (IC) manufacturing system 1002 which is configured to manufacture a processing system as described in any of the examples herein. In particular, the IC manufacturing system 1002 comprises a layout processing system 1004 and an integrated circuit generation system 1006. The IC manufacturing system 1002 is configured to receive an IC definition dataset (e.g. defining a processing system as described in any of the examples herein), process the IC definition dataset, and generate an IC according to the IC definition dataset (e.g. which embodies a processing system as described in any of the examples herein). The processing of the IC definition dataset configures the IC manufacturing system 1002 to manufacture an integrated circuit embodying a processing system as described in any of the examples herein.

The layout processing system 1004 is configured to receive and process the IC definition dataset to determine a circuit layout. Methods of determining a circuit layout from an IC definition dataset are known in the art, and for example may involve synthesising RTL code to determine a gate level representation of a circuit to be generated, e.g. in terms of logical components (e.g. NAND, NOR, AND, OR, MUX and FLIP-FLOP components). A circuit layout can be determined from the gate level representation of the circuit by determining positional information for the logical components. This may be done automatically or with user involvement in order to optimise the circuit layout. When the layout processing system 1004 has determined the circuit layout it may output a circuit layout definition to the IC generation system 1006. A circuit layout definition may be, for example, a circuit layout description.

The IC generation system 1006 generates an IC according to the circuit layout definition, as is known in the art. For example, the IC generation system 1006 may implement a semiconductor device fabrication process to generate the IC, which may involve a multiple-step sequence of photo lithographic and chemical processing steps during which electronic circuits are gradually created on a wafer made of semiconducting material. The circuit layout definition may be in the form of a mask which can be used in a lithographic process for generating an IC according to the circuit definition. Alternatively, the circuit layout definition provided to the IC generation system 1006 may be in the form of computer-readable code which the IC generation system 1006 can use to form a suitable mask for use in generating an IC.

The different processes performed by the IC manufacturing system 1002 may be implemented all in one location, e.g. by one party. Alternatively, the IC manufacturing system 1002 may be a distributed system such that some of the processes may be performed at different locations, and may be performed by different parties. For example, some of the stages of: (i) synthesising RTL code representing the IC definition dataset to form a gate level representation of a circuit to be generated, (ii) generating a circuit layout based on the gate level representation, (iii) forming a mask in accordance with the circuit layout, and (iv) fabricating an integrated circuit using the mask, may be performed in different locations and/or by different parties.

In other examples, processing of the integrated circuit definition dataset at an integrated circuit manufacturing system may configure the system to manufacture a processing system without the IC definition dataset being processed so as to determine a circuit layout. For instance, an integrated circuit definition dataset may define the configuration of a reconfigurable processor, such as an FPGA, and the processing of that dataset may configure an IC manufacturing system to generate a reconfigurable processor having that defined configuration (e.g. by loading configuration data to the FPGA).

In some embodiments, an integrated circuit manufacturing definition dataset, when processed in an integrated circuit manufacturing system, may cause an integrated circuit manufacturing system to generate a device as described herein. For example, the configuration of an integrated circuit manufacturing system in the manner described above with respect to FIG. 4 by an integrated circuit manufacturing definition dataset may cause a device as described herein to be manufactured.

In some examples, an integrated circuit definition dataset could include software which runs on hardware defined at the dataset or in combination with hardware defined at the dataset. In the example shown in FIG. 4, the IC generation system may further be configured by an integrated circuit definition dataset to, on manufacturing an integrated circuit, load firmware onto that integrated circuit in accordance with program code defined at the integrated circuit definition dataset or otherwise provide program code with the integrated circuit for use with the integrated circuit.

The implementation of concepts set forth in this application in devices, apparatus, modules, and/or systems (as well as in methods implemented herein) may give rise to performance improvements when compared with known implementations. The performance improvements may include one or more of increased computational performance, reduced latency, increased throughput, and/or reduced power consumption. During manufacture of such devices, apparatus, modules, and systems (e.g. in integrated circuits) performance improvements can be traded-off against the physical implementation, thereby improving the method of manufacture. For example, a performance improvement may be traded against layout area, thereby matching the performance of a known implementation but using less silicon. This may be done, for example, by reusing functional blocks in a serialised fashion or sharing functional blocks between elements of the devices, apparatus, modules and/or systems. Conversely, concepts set forth in this application that give rise to improvements in the physical implementation of the devices, apparatus, modules, and systems (such as reduced silicon area) may be traded for improved performance. This may be done, for example, by manufacturing multiple instances of a module within a predefined area budget.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein. In view of the foregoing description it will be evident to a person skilled in the art that various modifications may be made within the scope of the invention.

What is claimed is:

1. A computer-implemented method of processing an instruction by a processing unit, wherein the processing unit comprises an operation cache (OC) comprising a plurality of entries and a micro-operation cache (NOC) comprising a plurality of entries, and wherein the method comprises:
receiving, at the OC, an instruction to be processed by the processing unit;
storing, in an entry of the OC, state and control logic associated with the instruction;
splitting, by the OC, the instruction into a set of micro-operations;
sending, by the OC, each of the set of micro-operations to the OC;
storing, in respective entries of the μOC, respective state and respective control logic associated with respective micro-operations of the set of micro-operations; and
dispatching, by the μOC, one or more of the respective micro-operations for execution.

2. The method of claim 1, wherein the instruction comprises an original ordering of micro-operations, and wherein an ordering of the set of micro-operations differs from the original ordering.

3. The method of claim 1, wherein the instruction comprises an original number of micro-operations, and wherein the set of micro-operations comprises fewer than the original number of micro-operations.

4. The method of claim 2, wherein the ordering of the set of micro-operations and/or the splitting of the instruction into the set of micro-operations is based on the data to be processed by the instruction and/or architectural state.

5. The method of claim 1, wherein the set of micro-operations sent to the μOC in initial ordering, and wherein the method comprises dispatching, by the μOC, one or more of the respective micro-operations in an order that differs from the initial ordering.

6. The method of claim 1, further comprising the OC updating the state associated with the instruction during execution of the instruction.

7. The method of claim 1, further comprising the μOC updating the respective state associated with the respective micro-operations during execution of the respective micro-operations.

8. The method of claim 1, wherein dispatching of a respective micro-operation by the μOC comprises dispatching the respective micro-operation to a vector data path or a load-store unit of a memory system.

9. The method of claim 1, comprising emptying the respective entry of the μOC on completion of execution of the respective micro-operation.

10. The method of claim 1, further comprising emptying the entry of the OC on completion of execution of the instruction.

11. The method of claim 1, wherein the processing unit is a vector processing unit.

12. Computer readable code embodied in a non-transitory storage medium, configured to cause the method of claim 1 to be performed when the code is run.

13. A processing unit comprising:
an operation cache (OC) comprising a plurality of entries; and
a micro-operation cache (μOC) comprising a plurality of entries,
wherein the OC is configured to:
receive an instruction to be processed by the processing unit;
store, in an entry of the OC, state and control logic associated with the instruction;
split the instruction into a set of micro-operations; and
send each of the set of micro-operations to the μOC, and
wherein the μOC is configured to:
store, in respective entries of the μOC, state and control logic associated with a respective micro-operation of the set of micro-operations; and
dispatch, for execution, one or more respective micro-operations of the set of micro-operations.

14. The processing unit of claim 13, wherein the received instruction comprises an original ordering of micro-operations, and wherein the OC is configured to split the instruction into the set of micro-operations having an order differing from the original ordering.

15. The processing unit of claim 13, wherein the received instruction comprises an original number of micro-operations, and wherein the OC is configured to split the instruction into fewer that the original number of micro-operations to form the set of micro-operations.

16. The processing unit of claim 13, wherein the OC is configured to split the instruction into the set of micro-operations based on data to be processed by the instruction and/or architectural state of a processing system comprising the processing unit.

17. The processing unit of claim 13, wherein the OC is configured to send the set of micro-operations to the μOC in an initial order, and wherein the μOC is configured to dispatch the one or more respective micro-operations in an order differing from the initial order.

18. The processing unit of claim 13, wherein the entry of the OC is configured to update the state of the instruction during execution of the instruction.

19. The processing unit of claim 13, wherein each respective entry of the JOC is configured to update the respective state associated with the respective micro-operation during execution of the respective micro-operation.

20. A processing system comprising:
the processing unit as set forth in claim 13;
a control unit configured to send the instruction to the processing unit; and
a memory system comprising one or more load-store units, wherein the one or more load-store units are configured to receive and execute the one or more respective micro-operations dispatched by the μOC.
